(19) United States
(12) Patent Application Publication
(10) Pub. No.: US 2006/0059178 A1
(43) Pub. Date: Mar. 16, 2006

(54) Electronic mail indexing systems and methods

(75) Inventors: Mathieu Baron, Quebec (CA); Daniel Lavoie, Sainte-Foy (CA); Nicolas Pelletier, Charlesbourg (CA)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: COPERNIC TECHNOLOGIES, INC., Sainte-Foy (CA)

(21) Appl. No.: 11/208,429

(22) Filed: Aug. 19, 2005

Related U.S. Application Data
(60) Provisional application No. 60/603,334, filed on Aug. 19, 2004.
(60) Provisional application No. 60/603,335, filed on Aug. 19, 2004.
(60) Provisional application No. 60/603,336, filed on Aug. 19, 2004.
(60) Provisional application No. 60/603,366, filed on Aug. 19, 2004.

(51) Int. Cl. G06F 7/00

(52) U.S. Cl. 707/100

(57) ABSTRACT

Described herein are systems and methods for indexing documents in a quasi real-time manner. The method can include the steps of indexing documents and storing document information in a database, registering with an extended MAPI layer of an e-mail program for notification of changes to the documents, and responding to received notification of changes by updating the database to reflect the addition, modification, and/or deletion of documents. Unlike traditional document systems, the document index described herein can be updated without rescanning all the indexed documents.

### CROSS-REFERENCE TO RELATED APPLICATIONS

This application claims priority to U.S. Provisional Patent Application Ser. No. 60/603,366, entitled “PDF File Rendering Engine for Semantic Analysis,” filed Aug. 19, 2004. This application also claims priority to U.S. Provisional Patent Application Ser. No. 60/603,334, entitled “Usage of Idle CPU Time for Desktop Indexing,” filed Aug. 19, 2004; 60/603,335, entitled “On the Fly Indexing of Newly Added/Changed Files on a PC,” filed Aug. 19, 2004; and 60/603,336, entitled “On the Fly Indexing of Newly Added/Changed E-mails on a PC,” filed Aug. 19, 2004. All four of the foregoing provisional applications are hereby incorporated by reference in their entirety.

### FIELD OF THE INVENTION

The invention pertains to digital data processing and, more particularly, methods and apparatus of finding information on digital data processors. The invention has application, by way of non-limiting example, in personal computers, desktops, and workstations, among others.

### BACKGROUND OF THE INVENTION

Search engines for accessing information on computer networks, such as the Internet, have been known for some time. Such engines are typically accessed by individual users via portals, e.g., Yahoo! and Google, in accord with a client-server model.

Traditional search engines operate by examining Internet web pages for content that matches a search query. The query typically comprises one or more search terms (e.g., words or phrases), and the results (returned by the engines) typically comprise a list of matching pages. A plethora of search engines have been developed specifically for the web and they provide users with options for quickly searching large numbers of web pages. For example, the Google search engine currently purports to search over eight billion of web pages, e.g., in html format.

In spite of the best intentions of developers of Internet search engines, these systems have a limited use outside of the World Wide Web.

An object of this invention is to provide improved methods and apparatus for digital data processing.

A related object of the invention is to provide such methods and apparatus for finding information on digital data processors. A more particular related object is provide such methods and apparatus as facilitate finding information on personal computers, desktops, and workstations, among others.

Yet still another object of the invention is to provide such methods and apparatus as can be implemented on a range of platforms such as, by way of non-limiting example, Windows™ PCs.

Still yet another object of the invention is to provide such methods and apparatus as can be implemented at low cost.

Yet still yet another object of the invention is to provide such methods and apparatus as execute rapidity and/or without substantially degrading normal computer operational performance.

### SUMMARY OF THE INVENTION

The foregoing are among the objects achieved by the invention, which provides in one aspect a method of updating a database. For example, the method can comprise the steps of indexing electronic mail documents (“email”) and storing document information in a database. Unlike traditional document systems, the document database described herein can be updated without rescanning all the indexed documents. The indexing method can monitor changes to the indexed documents and update the database in a real-time manner to perform incremental updates each time a change occurs.

The method can include the steps of registering with the extended MAPI layer of an email program for notification of changes to the documents. When a notification is received regarding a change to a document, the database can be updated to reflect the addition, modification, and/or deletion of documents.

The database can include a series of folders that contain information such as unique documents identifiers, key word, the status of documents, and other information about the indexed files. For example, the database can include a document database file and a keyword database file. Other files can include slow data files, document ID index files, fast data files, URI index files, deleted document ID index files, lexicon files, and document list files.

In one aspect, the step of indexing documents is performed on a local drive. However, one skilled in the art will appreciate that network files and drives can be similarly indexed.

In another aspect, the step of indexing includes assigning each document a unique document identifier. For example, step of indexing can include storing the unique document identifiers and associated document URIs in a file and/or storing a unique document identifier and a keyword for each indexed document in a file.

The method can further include the step of responding to notifications by storing information about the deleted status of an email document in a file. For example, when the system receives notification that an email is deleted, the document ID for that file can be stored in a deleted document ID index file. When the system receives notice that a new email document is added, the step of responding to a notification can includes reserving a new unique document identifier for a new document, adding a document to a document database by writing a new entry for the new document, and associating the new document with a keyword.

To protect against the loss of data, the method can further include a pre-commit stage, in which the database can be rolled back to its pre-document-addition state if the system unexpectedly shuts down. In one aspect, the pre-commit or commit status of documents are stored in a file.

Once the documents are indexed, the method can further include searching the database for documents matching a keyword. One skilled in the art will appreciate that the step of searching can occur at any time. For example, a search can be performed shortly after receiving notification of a status change to a document, and the new status will be reflected in the search.

In another aspect, indexing is paused when CPU usage rises above a threshold value. For example, the method can include the step of monitoring at least one of a mouse and a keyboard and pausing the indexing when at least one of the mouse and keyboard is used.

In another embodiment described herein, an indexing system is described. The system can include an indexer for indexing email documents and a document database in communication with the indexer. The document database can store unique identifiers for each indexed document. The indexer registers with the operating systems, which detects the addition, modification, and/or deletion of email documents. The operating system signals the indexer when any of those events occur.

### BRIEF DESCRIPTION OF THE DRAWINGS

The foregoing features, objects and advantages of the invention will become apparent to those skilled in the art from the following detailed description of the illustrated embodiment, especially when considered in conjunction with the accompanying drawings.

FIG. 1 depicts an architecture of desktop indexing system 10 according to one practice of the invention. The illustrated system 10 includes a set of indexing system files and/or databases containing information about user files (or “documents”) that are indexed by the system.

FIG. 2 is a schematic view of the pre-commit/commit procedure used to assure data integrity in a system according to the invention. If the system unexpectedly crashes before a document is properly indexed, the database can be rolled back to its state before the interrupt occurred.

FIG. 3A is a schematic view of a Lexicon Item and an associated Bucket in a system according to the invention.

FIG. 3B is a schematic view of the Lexicon Item and Bucket of FIG. 3A after the arrival of a new document that matches an existing keyword.

FIG. 3C is a schematic view of the Lexicon Item and Bucket of FIG. 3B after a roll back.

FIG. 3D is a schematic view of the Lexicon Item and Bucket of FIG. 3C after the arrival of document 104.

### DETAILED DESCRIPTION

We have designed an indexer that uses idle CPU time to index the personal data contained on a PC. The purpose of such a technology is to perform the indexing operations in the background when the user is away from its computer. That way, the index can be incrementally updated over time while not affecting the computer's performance.

As used herein, the terms “desktop,” “PC,” “personal computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

Likewise, the term “document” or “user data,” unless otherwise evident from context, refers to digital data files indexed by systems according to the invention. These include by way of non-limiting example word processing files, “pdf” files, music files, picture files, video files, executable files, data files, configuration files, and so forth. When CPU use rises above a threshold level, the indexing is paused. The indexing is also paused when the users types on the keyboard or moves the mouse. This creates a unique desktop indexer that is completely transparent to the user since it never requires computer resources while the PC is being used.

For the CPU usage monitoring, different sets of technologies can be used depending of the operating system.

On Windows NT-based operating systems (Windows NT4/2000/XP), the “Performance Data Helper” API can monitor CPU usage. Numerous “Performance Counters” are available from this API. The algorithms we are using include the following:

```
Every 5 Seconds:
Check Performance Counters
If (Idle Process) + (Desktop Indexing Process) < 50% Then
    Pause Indexing
On Windows 9x (95/98/Me), the “Performance Data Helper” API is not
available. Instead, the indexing system can rely on more primitive
function calls of the operating system. One such algorithm is the
following:Every 20 Seconds:
Pause Indexing for 1.75 Seconds
    Check Kernel Usage
    If (Kernel Usage) = 100% Then
        Pause Indexing
```

The monitoring of mouse and keyboard usage can be the same manner for all operating systems. Each time the mouse or the keyboard is used by the user, the indexing process is paused for the next 30 seconds.

```
SOURCE CODE EXCERPT —CPU MONITORING FOR WINDOWS 95/98/ME:
    function TCDLCPUUsSageMonitorWin9x.Start: Boolean;
    * * *
    begin
        * * *
        FReg.RootKey := HKEY_DYN_DATA;
        // before data is available, you must read the START key for
        the data you desire
        FReg.Access := KEY_QUERY_VALUE;
        if FReg.TryOpenKey(CPerfKey + CPerfStart) then
        begin
            BufferSize := Sizeof(DataBuffer);
            if FReg.TryReadBinaryData(CPerfUsage, DataBuffer,
            BufferSize) then
            * * *
        end; // TryOpenKey
    * * *
    end;
SOURCE CODE EXCERPT —CPU MONITORING FOR WINDOWS NT:
    function TCDLCPUUSsageMonitorWinNT.UpdateUsage: Boolean;
    * * *
    begin
    * * *
    if GetFormattedCounterValue(FTotalCounter, PDH_FMT_LARGE, nil,
    FTotalCounterValue) = ERROR_SUCCESS then
        // Check if data is valid
        if FTotalCounterValue.CStatus = PDH_CSTATUS_VALID_DATA then
        begin
            if FExcludeProcess then
            begin
                // Get the countervalue in int64 format
                if GetFormattedCounterValue(FLongProcessCounter,
                PDH_FMT_LARGE, nil, FProcessCounterValue) =
                ERROR_SUCCESS then
                    ValueFound := True
                else if
                GetFormattedCounterValue(FLimitedProcessCounter,
                PDH_FMT_LARGE, nil, FProcessCounterValue) =
            ERROR_SUCCESS then
                    ValueFound := True
                else if
                GetFormattedCounterValue(FShortProcessCounter,
                PDH_FMT_LARGE, nil, FProcessCounterValue) =
                ERROR_SUCCESS then
                    ValueFound := True;
        * * *
    end;
SOURCE CODE EXCERPT —USER ACTIVITY MONITORING:
    BOOL SetHooks( )
    {
        BOOL succeeded = FALSE;
        g_Notifier.m_MouseHook = SetWindowsHookEx(WH_MOUSE,
        (HOOKPROC) &MouseHookProc, g_InstanceHandle, 0);
        g_Notifier.m_KeyboardHook = SetWindowsHookEx(WH_KEYBOARD,
        (HOOKPROC) &KeyboardHookProc, g_InstanceHandle, 0);
        if (g_Notifier.m_MouseHook != 0 && g_Notifier.m_KeyboardHook
        != 0) {
        succeeded = TRUE;
        } else {
            UnsetHooks( );
        }
        return succeeded;
    }
SOURCE CODE EXCERPT —OUTLOOK MONITORING:
    function TCDLMsgStoreAdviseSink.Advise(AEventMask: ULong): ULong;
    var
      MapiAdviseSinkImpl: IMAPIAdviseSink;
      ThreadSafeAdviseSink: IMAPIAdviseSink;
      PropValues: TCDLPropValues;
    begin
      MapiAdviseSinkImpl := TMapiAdviseSinkImpl.Create(Self);
      HrThisThreadAdviseSink(MapiAdviseSinkImpl, ThreadSafeAdviseSink);
      MapiCheck(
        FMsgStore.GetMsgStoreIntf.Advise(0, nil, AEventMask, ThreadSafeAdviseSink,
    Result));
    <--cut-->
        PropValues := TCDLPropValues.Create(FMsgStore.GetMsgStoreIntf,
    [PR_TEST_LINE_SPEED]);
        FreeAndNil(PropValues);
    <--cut-->
    end;
```

The challenge behind the Desktop Search system is to design a powerful and flexible indexing technology that works efficiently within the desktop environment context. The desktop indexing technology is designed with concerns specific to the desktop environment in mind. For example:
The system can preferably run on most desktop configurations.
   Windows 95/98/Me/NT/2000/XP
   Low physical memory
   Low disk space
When running in background, the indexer preferably does not interfere with the foreground applications.
The index can be fault-tolerant
   If the computer crashes, index corruption is prevented by a “transactional commit” approach.
The index can be searchable at any time.
   The user will be able to search while the Index is being updated.
   The user will be able to find newly added documents as soon as they are indexed (even if the temporary index has not yet been merged into the main index).
The query engine can find matching results in less than a second for most of the queries.
Other design preferences include, for example:
   The total download size can be under 2.5 MB
      The download size is 1.88 MB (without the deskbar)
      The download size is 2.23 MB (with the deskbar)
   The indexer preferably does not depend on any third-party components
      All the following components are preferably unique to the indexing system described herein.
         Charset detection algorithms
         Charset conversion algorithms
         Language detection algorithms
         Document conversion algorithms (Document->Text)
         Document preview algorithms (Document->HTML)
   The query engine can allow to search as the user types its query.
      Supports prefix search (a query with only the letter a returns all document with a keyword starting with the letter a).
   The query engine can support Boolean operators and fielded searches (ex.: author, from/to, etc.)
      Supports AND/OR/NOT operators.
      Supports metadata Indexing.
      Supports metadata queries using the following format: @customfieldname=query.
   The index can store additional information for each document (if needed).
      Cached HTML version of documents (in build 381, document previews are rendered live and are not cached in the index).
      Keywords occurrence/position (not added in build 381 for disk usage limitations).
         File Structure

The desktop search index contains two main databases:
Documents Database
Keywords Database

The structure of each component is described in the following sections.

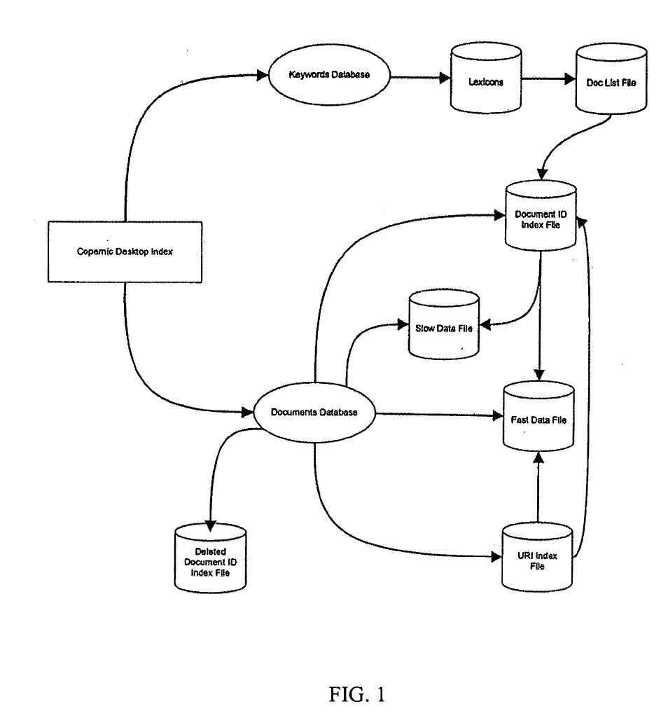

FIG. 1 depicts an architecture of desktop indexing system 10 according to one practice of the invention. The illustrated system 10 includes a set of indexing system files and/or databases containing information about user files (or “documents”) that are indexed by the system.

Documents Database

Documents Database 14 (referred as DocumentDB) contains data about the indexed documents. It can store the following document information:
Document ID (referred as DocID)
Document URI (referred as DocURI)
Document date
Document content (if any associated)
Documents fields (file size, title, subject, artist, album and all other custom fields)
A list of deleted DocIDs
   File Listing

The Document DB is coupled with a variety of sub-components, such as, for example:

| File | File Name | Summary |
|---|---|---|
| Documents DB Info File | Documents.dif | Stores Documents DB version |
| | | and transaction information |
| | | (commit/precommit state). |
| Document ID Index File | Documents.did | The ID map is the heart of the |
| | | documents DB. This file |
| | | contains information about all |
| | | documents, ordered by Doc |
| | | IDs. |
| Fast Data File | Documents.dfd | Contains documents URI and |
| | | commonly used fields (“fast |
| | | fields”). |
| Slow Data File | Documents.dsd | Contains Documents content |
| | | (if any) and other fields |
| | | (“slow fields”). |
| URI Index File | Documents.dur | Data used to fetch the Dod D |
| | | for a specified URI. |
| Deleted Document ID | Documents.ddi | Stores the I1st of deleted Doc |
| | | IDs. |

File Details: Documents DB Info File (Documents.dif)

The Documents DB Info File 18 can store version and transaction information for the Documents DB. Before opening other files, documents DB 14 validates if the file version is compatible with the current version.

If the DB format is not compatible, data must be converted to the current version. Document DB Info File 18 also can store the transaction information (committed/pre-committed state) for the Documents DB. The commit/pre-commit procedure is described in more detail below.

File Details: Document ID Index File (Documents.did)

The ID map is the heart of the documents DB. Document ID index file 20 consists of a series of items ordered by DocIDs. The size of each item can be static.

Structure of Items in a Document ID Index File

| | DATA | | | | | | | | | |
|---|---|---|---|---|---|---|---|---|---|---|
| | | | | | | fast | fast | slow | slow | |
| | | Doc | Doc | | | fields | fields | fields | fields | |
| KEY | Doc | URI | URI | additional | additional | map | map | map | map | |
| Doc ID | date | offset | size | info offset | info size | offset | count | offset | count | reserved |
| 4 bytes | 8 bytes | 4 bytes | 4 bytes | 4 bytes | 4 bytes | 4 bytes | 4 bytes | 4 bytes | 4 bytes | 4 bytes |

| | |
|---|---|
| Field | Description |
| Doc ID | Key of the record. To get the offset, from the beginning of the file, for |
| | a specific DocID: DocID * SizeOf(ItemSize). |
| Doc Date | Modified date of the document. This field is used to check if the |
| | document needs to be re-indexed. |
| Doc URI Offset | Offset of the doc URI in the data file. The document URI is stored in |
| | the Fast Data File (see Fast Data Flle section for more details). The |
| | URI is stored in UCS2. |
| Doc URI Size | Size (in bytes) of the Doc URI, without the null termination character. |
| Additional Info | Offset (if any) of the associated additional information (such the |
| | document content) in the Slow Data File (see Slow Data File section |
| | for more details). |
| Additional Info Size | Size of the additional information (in bytes). |
| Fast Fields Map Offset | Offset of associated fast custom fields in the fast data file (see Fast |
| | Data File section for more details). |
| Fast Field Map Count | Number of fast fields associated with the document (see Fast Data |
| | File section for more details). |
| Slow Fields Map Offset | Offset of associated slow fields in the slow data file (see Slow Data |
| | File section for more details). |
| Slow Fields Map Count | Number of slow fields associated with the document (see Slow Data |
| | File section for more details). |
| Reserved | Reserved for future use. |

File Details: Fast Data File (Documents.dfd)

Fast data file 22 contains the documents URIs and the Fast Fields. Fast fields are the most frequently used fields.

In fast data file 22, all strings values can be stored in UCS2. This accelerates items sorting. In the slow data file, all strings can be stored in UTF8.

The “Fast Fields Map Offset” from “ID Index File” points to an array of field info. Fields are sorted by Field ID to allow faster searches.

Fast Data File: Field Information

| | Field data (structure |
|---|---|
| Field ID | depends on the field type) |
| 4 bytes | 8 bytes |

| | |
|---|---|
| Field | Description |
| Field ID | Numeric unique identifier for the field. |
| Field Data | Field data information. This depends on the type (string, |
| | integer and date) of the field. See below for more details for |
| | each data type. |

Field Data: String

| Field ID | String Offset |
|---|---|
| 4 bytes | 4 bytes |

| | |
|---|---|
| Field | Description |
| String Length | Length of the string (in characters). |
| String Offset | Offset of the string. Offset 0 is the first byte after the last |
| | item of the field into array. |
| | In the Fast Data File, strings values are stored in UCS2. |

Field Data: Integer

| Integer Value | Unused |
|---|---|
| 4 bytes | 4 bytes |

| | |
|---|---|
| Field | Description |
| Integer Value | Integer values are directly stored in the field data. |
| Unused | There are 4 unused bytes for Integer fields (for alignment |
| | purpose). |

Field Data: Date

Date Value
8 bytes

| | |
|---|---|
| Field | Description |
| Date Value | Date values are directly stored in the field data. |

File Details: Slow Data File (Documents.dsd)

Slow data file 24 contains slow fields for each document and may contain additional data (such as document content). Slow fields are the least frequently used fields.

In the slow data file, all strings can be stored in UTFB to save disk space.

The “Slow Fields Map Offset” from “ID Index File” points to an array of field info. Fields are sorted by Field ID to allow faster searches.

Slow Data File: Field Information.

| | Field data (structure depends on |
|---|---|
| Field ID | the field type |
| 4 bytes | 8 bytes |

| | |
|---|---|
| Field | Description |
| Field ID | Numeric unique identifier for the field. |
| Field Data | Field data information. This depends on the type (string, |
| | integer and date) of the field. See below for more details for |
| | each data type. |

Field Data: String

| Field ID | String Offset |
|---|---|
| 4 bytes | 4 bytes |

| | |
|---|---|
| Field | Description |
| String Length | Length of the string (in characters). |
| String Offset | Offset of the string. Offset 0 is the first byte after the last |
| | item of the field info array. |
| | In the Slow Data File, strings are stored in UTF8. |

Field Data: Integer

| Integer Value | Unused |
|---|---|
| 4 bytes | 4 bytes |

| | |
|---|---|
| Field | Description |
| Integer Value | Integer values are directly stored in the field data. |
| Unused | There are 4 unused bytes for Integer fields (for alignment |
| | purpose). |

Field Data: Date

Date Value
8 bytes

| | |
|---|---|
| Field | Description |
| Date Value | Data values are directly stored in the field data. |

File Details: URI Index File (Documents.dur)

URI index file 26 contains all URIs and the associated DocIDs. The system can access URI index file 26 to fetch the DocIDs for a specified URI. This file is usually cached in memory.

Structure of Items in the URI Index File

| DOC URI OFFSET | DOC URI SIZE | DOC ID |
|---|---|---|
| 4 BYTES | 4 BYTES | 4 BYTES |

| | |
|---|---|
| Field | Description |
| Doc Uri Offset | The offset of the document URI in the data file. The |
| | document URI is stored in the Fast Data File. The URI is |
| | stored in UCS2. |
| Doc Uri Size | The size (in bytes) of the Doc URI, without the null |
| | termination char. |
| Doc ID | The DodID associated with this URI. |

File Details: Deleted Document ID Index File (Documents.ddi)

Deleted document ID index file 28 contains information about the deleted state of each DocID. An array of bit within the file can alert a user of the state of each document: if the bit is set, the DocID is deleted. Otherwise, the DocID is valid (not deleted). The first item in this array is the deleted state for DocID #0; the second item is the deleted state for DocID #1, and so on. The number of bits is equal the number of documents in the index. This file is usually cached in memory.

Structure of Items in the Deleted Document ID Index File

INDEXED BY DOC ID
IS DOC ID DELETED
1 BIT

Keywords Database

Keyword DB 16 (referred as KeywordsDB) contains keywords and the associated DocIDs. In the KeywordsDB, a keyword is a pair of:
The field ID
The field value

So if the word “Hendrix” is located as an artist name and also as an album name, it will be stored twice in the KeywordDB:
FieldID: ID_ARTIST; FieldValue: “Hendrix”
FieldID: ID_ALBUM; FieldValue: “Hendrix”

The keywordsDB use chained buckets to store matching DocIDs for each keyword. Buckets sizes are variable. Every time a new bucket is created, the index allocates twice the size of the previous bucket. The first created bucket can store up to 8 DocIDs. The second can store up to 16 DocIDs. The maximum bucket size is 16,384 DocIDs.

Optimization: 90% of the keywords match less than four documents. In this case, the matching DocIDs are inlined directly in the lexicon, not in the doc list file. See below for more information.

File Listing

| File | File Name | Summary |
|---|---|---|
| Keyword | Keywords.kif | Stores the transaction information |
| DB Info File | | for the Keyword DB (committed/pre- |
| | | committed state) |
| Lexicon (strings) | Keywords.ksb | Stores string keyword information |
| Lexicon (integers) | Keywords.kib | Stores integer keyword information |
| Lexicon (dates) | Keywords.kdb | Stores date keyword information |
| Doc List File | Keywords.kdl | Contains chained buckets containing |
| | | DocIDs associated with keywords |

File Details: Keyword DB Info File (Keywords.kif)

Keyword DB Info File 30 contains the transaction information (committed/pre-committed state) for the Keyword DB. See the Transaction section for more details.

File Details: Lexicons (Keywords.ksb/.kib/.kdb)

Lexicon file 32 can store information about each indexed keyword. There is a lexicon for each data type: string, integer and date. The lexicon uses a BTree to store its data.

To optimize disk usage and search performance, the index uses two different approaches to save its matching documents, depending on the number of matches.

Lexicon Information when Num Matching Docs<=4

| KEY | | Data | | | | |
|---|---|---|---|---|---|---|
| | Keyword | Num. Matching | Inlined Doc | Inlined Doc | Inlined Doc | Inlined Doc |
| Field ID | Value | Documents | #1 | #2 | #3 | #4 |
| 4 bytes | variable size | 4 bytes | 4 bytes | 4 bytes | 4 bytes | 4 bytes |
| | (contains the | | | | | |
| | key value) | | | | | |

| | |
|---|---|
| Field | Description |
| Field ID | Part of the key. The field ID specifies which custom field the value |
| | belongs to. |
| Keyword Value | Keyword value. String values are stored in UTF8. |
| Num Matching | Number of DocIDs matching this keyword. When the Number of |
| | Matching Documents <=4, DocIDs are inline in the record so there is |
| | no need to create buckets because the current structure contains |
| | enough space to store up to four DocIDs. |
| Inlined Doc #1 | First matching DocID. |
| Inlined Doc #2 | Second matching DocID (if any). |
| Inlined Doc #3 | Third matching Dod D (if any). |
| Inlined Doc #4 | Fourth matching DocID (if any). |

Lexicon Information when Num Matching Docs>4

| KEY | | Data | | | | |
|---|---|---|---|---|---|---|
| | Keyword | Num. Matching | Last Bucket | Last Bucket | Last Bucket | Last Seen |
| Field ID | Value | Documents | Offset | Size | Free Offset | Doc ID |
| 4 bytes | variable size | 4 bytes | 4 bytes | 4 bytes | 4 bytes | 4 bytes |
| | (contains the | | | | | |
| | key value) | | | | | |

| | |
|---|---|
| Field | Description |
| FieldID | Part of the key. The field ID specify for which custom field the value |
| | refers. |
| Keyword Value | Keyword value. String values are stored in UTF8. |
| Num Matching | Number of DocIDs matching this keyword. When the Number of |
| | Matching Documents <= 4, DocIDs are inline in the record so there is |
| | no need to create buckets because the current structure contains |
| | enough space to store up to four DocIDS. |
| Last Bucket Offset | Offset to the last chained bucket in the DocListFile. |
| Last Bucket Size | Size (in bytes) of the last bucket. |
| Last Bucket Free Offset | Offset of the next free spot In the last bucket. If there is not enough |
| | space, a new bucket is created. |
| Last Seen Doc ID | Last associated DocID for this keyword. Internally used for |
| | optimization purpose. Since DocIDs can only increase, this value is |
| | used to check if a DocID has already been associated with this |
| | keyword. |

File Details: Doc List File (Keywords.kdl)

Doc List File 34 can contain chained buckets containing DocIDs. When a bucket is full, a new empty bucket is created and linked to the old one (reverse chaining: the last created bucket is the first in the chain).

Structure of a Bucket in the Doc List File

| Next Bucket | Next Bucket | Matching Doc ID | | Matching Doc |
|---|---|---|---|---|
| Offset | Size | #1 | . . . | ID #X |
| 4 bytes | 4 bytes | 4 bytes | | 4 bytes |

| Field | Description |
|---|---|
| Next Bucket Offset | Offset to the next chained bucket |
| | (if any) in the DocListFile. |
| Next Bucket Size | Size (in bytes) of the next bucket. |

Transactions

Transactions are used to keep data integrity: every data written in a transaction can be rolled back at any time.

When a change is made to the index (a new document is added or a document is deleted), the new data is written in a transaction. Transactions are volatile and preferably never directly modify the main index content on the disk until they are applied.

At any time, an open transaction can be rolled back to undo pending modifications to the index. When a rollback occurs, the index returns to its initial state, before the creation of the transaction.

Recovery Management

Transaction Model

Each recoverable file that implements the indexer transaction model must follow four rules:
1. Active transactions must be transparent. In other terms, the user must be able to search the documents that are stored In a transaction.
2. After a successful call to pre-commit, the data must stay in pre-committed mode even after a system restart.
3. When the index is in pre-commit mode, data cannot be read or written. The only available operations are Commit and Rollback.
4. Rollback can be called in any state and must rollback to the last successful commit state.
   Two Phases Commit

When a transaction needs to be merged within the main index, it can execute two phases. The first phase is called Pre-Commit.

Pre-Commit prepares the merging of the transaction within the main index. When the pre-commit phase has been called, the file must be able to rollback to the latest successful commit. In this phase, data cannot be read or written.

The second commit phase is called the final commit. Once the final commit is done, the data cannot be rolled back anymore and the data represent the “Last successful commit.” In other terms, the transaction becomes merged to the main index.

Two Phases Commit:

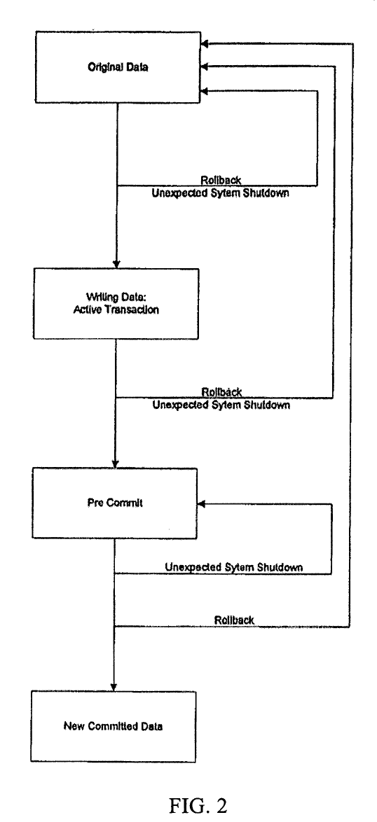

FIG. 2 illustrates a Data Flow Chart for the two phase commit.

File Synchronization

Since the Documents DB and the Keyword DB each use many separate files, the files states can be synchronized to insure data integrity. Every file using transactions in the databases should always be in the same state. If the state synchronization fails, every transaction is automatically rolled back.

The files in the databases are always pre-committed and committed in the same order. When a rollback occurs, files are rolled back in the reverse order.

### EXAMPLE 1

### Everything is OK Because All the Files are Committed

| File | Data State |
|---|---|
| File 1 | Committed |
| File 2 | Committed |
| File 3 | Committed |

### EXAMPLE 2

### The System Crashed between the Pre-Commit of File 2 and File 3

Everything must be rolled back; otherwise the files won't be synchronized if File 3 has lost some data during the system shutdown.

| File | Data State |
|---|---|
| File 1 | Pre-Committed |
| File 2 | Pre-Committed |

Unexpected system shutdown

| | |
|---|---|
| File 3 | Auto-Rolled back |

### EXAMPLE 3

### The System is in a Stable State, Files can be Committed or Rolled Back

| File | Data State |
|---|---|
| File 1 | Pre-Committed |
| File 2 | Pre-Committed |
| File 3 | Pre-Committed |

### EXAMPLE 4

### From Example 3, the User Chooses to Rollback

The rollback operation is executed on each file in reverse order and all the index data returns to its initial “Committed” data state.

### EXAMPLE 5

### From Example 3, the User Chooses to Commit

If the system crashes between committing the File 1 and the File 2, the data state also becomes invalid. However, in this case, File 1 has been successfully Committed and the other files are still in pre-committed state. The Pre-Committed state allows the indexer to resume committing with the File 2 and 3, because File 1 has been successfully Committed.

| File | Data State |
|---|---|
| File 1 | Committed |

Unexpected system shutdown

| | |
|---|---|
| File 2 | Pre-Committed |
| File 3 | Pre-Committed |

Recovery Implementations

There are 3 implementations of recoverable files in the Desktop Search index. Each implementation follows the rules of the Desktop Search “Transaction Model” (for more details, see Transaction Model section above).

Recovery Implementation for “Growable Files Only”

This implementation is used when the actual content is never modified: the new data is always appended in a temporary transaction at the end of the file.

This type of file keeps a header at the beginning of the file to remember the pre-committed/committed state.

The main benefit of this implementation is the low disk usage while merging into the main index. Since all data are appended to the file without altering the current data, there is no need to copy files when committing.

Header

This is the header of the file to remember the data state.

| Main | Pre-commit | Pre-commit | Committing | Committing |
|---|---|---|---|---|
| Index | Size | File | Size Valid | File |
| Size | Valid (Boolean) | Size | (Boolean) | Size |
| 4 bytes | 4 bytes | 4 bytes | 4 bytes | 4 bytes |

These values are separated in 2 categories:
Committed information: Main Index Size, Committing Size valid, Committing File Size.

Pre-Commit Information: Pre-commit Size Valid, Pre-commit file size.

| Initialization | | |
|---|---|---|
| Field | Value | Meaning/Data State |
| Pre-Commit Size Valid | False | Committed. The file is truncated at |
| | | the committed file size. |
| Pre-Commit Size Valid | True | Pre-Committed. Can rollback or |
| | | commit. |
| Committing Size Valid | False | The valid committed size is located in |
| | | Main Index Flle Size |
| Committing Size Valid | True | The valid committed size is located in |
| | | Committing File Size |

Rollback

Since data can only be written at the end of the file, the only thing to do is to truncate the file to rollback.

Pre-Commit

To pre-commit this type of file, the file header must be updated to:
Pre-Commit File Size→Actual transaction size
Pre-Commit Size Valid→True

Example: Pre-commit for a file size of 50 bytes

Original Header

| Main | Precommit | Precommit | Committing | Committing |
|---|---|---|---|---|
| Index Size: | Size Valid: | File Size: | Size Valid: | File Size |
| 10 | False | (unspecified) | False | 10 |

Write “Pre-commit File Size”: 50

| Main | Precommit | Precommit | Committing | Committing |
|---|---|---|---|---|
| Index Size: | Size Valid: | File Size: | Size Valid: | File Size |
| 10 | False | 50 | False | 10 |

Write “Pre-commit Size Valid”: True

| Main | Precommit | Precommit | Committing | Committing |
|---|---|---|---|---|
| Index Size: | Size Valid: | File Size: | Size Valid: | File Size |
| 10 | True | 50 | False | 10 |

The file is now in pre-commit mode:

| Field | Value | Meaning/Data State |
|---|---|---|
| Pre-Commit Size Valid | True | Pre-Committed. Can rollback |
| | | or commit. |

Commit

To commit this type of file, the file header must be updated to:
Committing File Size→50
Committing Size Valid→True
Pre-Commit Size Valid→False
Main Index Size: 50
Committing Size Valid→False

Example:

Committing File Size→50

| Main | Precommit | Precommit | Committing | Committing |
|---|---|---|---|---|
| Index Size: | Size Valid: | File Size: | Size Valid: | File Size |
| 10 | True | 50 | False | 50 |

Committing Size Valid→True

| Main | Precommit | Precommit | Committing | Committing |
|---|---|---|---|---|
| Index Size: | Size Valid: | File Size: | Size Valid: | File Size |
| 10 | True | 50 | True | 50 |

Because the commit size is now valid and greater than the Main Index Size, the commit is successful. The next step is to update the other information for a future transaction.

Pre-Commit Size Valid→False

| Main | Precommit | Precommit | Committing | Committing |
|---|---|---|---|---|
| Index Size: | Size Valid: | File Size: | Size Valid: | File Size |
| 10 | False | 50 | True | 50 |

Main Index Size→50

| Main | Precommit | Precommit | Committing | Committing |
|---|---|---|---|---|
| Index Size: | Size Valid: | File Size: | Size Valid: | File Size |
| 50 | False | 50 | True | 50 |

Committing Size Valid→False

| Main | Precommit | Precommit | Committing | Committing |
|---|---|---|---|---|
| Index Size: | Size Valid: | File Size: | Size Valid: | File Size |
| 50 | False | 50 | False | 50 |

The file is now fully committed and the items added in the transaction are now entirely merged into the main index. The index is now in committed state without any pending transaction.

Recovery Implementation for BTree (Lexicon)

The beginning of the file contains information on leafs (committed and pre-committed leafs). Leafs are not contiguous in the file so there is a lookup table to find the committed leafs.

When data is written into a leaf, the leaf is flagged as dirty. Dirty leafs are written back elsewhere in the file, in an empty space. During in a transaction, there are two versions of the data (modified leafs) in the file.

Initialization

Read leafs allocation table to find where they are located in the file.

Rollback

Flush all dirty leafs and reload original leaf allocation table.

Pre-Commit

Write a new leaf allocation table containing information about modified leafs. When the process is completed, a flag is set in the header to indicate where the pre-committed allocation table is located in the file.

Commit

Replace the official allocation table by the pre-commit one. The pre-committed leaf allocation table is not copied over the current one: the offset pointer located in the file header is updated to point to the new leaf.

Recovery Implementation for DocListFile

The DocList file is a “Growable Files Only.” All new buckets are appended at the end of the file and can easily be rolled back using the “Growable File Only” Rollback technique.

In some cases, new DocIDs are added in existing buckets. The “Growable Files Only” technique cannot be applied in this case to insure data integrity. In this case, the data integrity management is done by the Lexicon. It keeps information on the last bucket and the last bucket free offset.

Example:

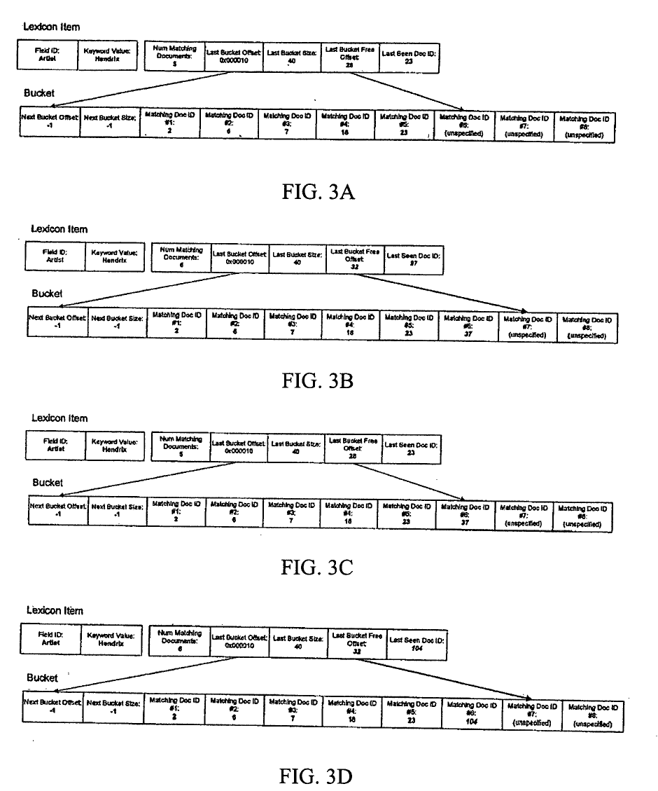

FIG. 3A illustrates an exemplary Lexicon Item and associated Bucket.

When a new document matches (DocID #37) an existing keyword, the system associates the new DocID #37 in the DocListFile:

FIG. 3B illustrates FIG. 3A after the arrival of DocID #37.

If files are rolled back, the bucket “Matching Doc ID #6” will not be restored to its original value because it uses the “Growable File Only” technique. This is not an issue because if a rollback occurs, the bucket space will still be marked as free.

After a rollback, the lexicon is restored to its original value and data files will be synchronized. Rolled back version:

FIG. 3C illustrates FIG. 3B after rollback.

FIG. 3D illustrates FIG. 3C after associating the keyword with a new DocID: 104.

Recovery Implementation for Very Small Data Files

This method only is used for very small data files only because it keeps all data in memory. When data is written to the file, it enters in transaction mode; but every modification is done in memory and the original data is still intact in the file on the disk. This method is used to handle the deleted document file.

Initialization

Load all data from the file in memory.

Rollback

The rollback function for this recovery implementation is basic: the only thing to do is to reload data from the file on the disk.

Pre-Commit

The pre-commit is done in 2 steps:
1. A temporarily file based on the original file name is created. If the original file name is “Datafile.dat”, the temporary file will be named “Datafile.dat˜”. The memory is dumped in this temporary file.
2. Once the memory is dumped in the temp file, the temp file is renamed under the form “Datafile.dat!” When there is file with a “!” appended to the name, this mean the data file is in pre-commit mode.

If an error occurs between step 1 and step 2, there will be a temporary file on the disk. Temporary files are not guaranteed to contain valid data so temporary files are automatically deleted when initializing the data file.

Commit

The commit is done in 2 steps:
1. Delete the original file name.
2. Rename the pre-committed file (“Datafile.dat!”) into the original file name.

If an error occurs between step 1 and 2, there will be a pre-committed file and no “official” committed file. In this case, the pre-commit file is automatically upgraded to committed state in the next file initialization.

Operations

When performing an operation (Add, Delete or Update) for the first time, the Index enters in transaction mode and the new data is volatile until a full commit operation is performed.

Add Operation

To add a document in a transaction, the indexer executes the following actions:
1. Reserve a new unique DocID
2. Add the document to the document DB:
   Write the URI in the Fast Data File
   Associate Fast Fields in the Fast Data File
   Associate Slow Fields in the Slow Data File
   Associate Additional content (if any) in the Slow Data File
   Write a new entry for this document in the Document ID Index File
   Write a new entry for this document in the URI Index File
3. Associate documents to keywords in the lexicon
   For each fields: associate every keywords

The documents are available for querying immediately after step 2.

Delete Operation

When a document is deleted, the indexer adds the deleted DocID to the Deleted Document ID Index File. The deleted documents are automatically filtered when a query is executed. The deleted documents remain in the Index until a shrink operation is executed.

Update Operation

When a document is updated, the old document is deleted from the index (using the Deleted Document ID Index File) and a new document is added. In other terms, the Indexer performs a Delete operation and then an Add operation.

Implementation in Desktop Search

This section provides a quick overview about how the Desktop Search system manages indexing operations and queries on the index.

Index Update

The Desktop Search system can use an execution queue to run operations in a certain order based on operation priorities and rules. There are over 10 different types of possible operations (crawling, indexing, commit, rollback, compact, refresh, update configuration, etc.) but this document will only discuss some of the key operations.

### Crawling Operation

When a crawling operation (file, email, contacts, history or any other crawler) is executed, it adds (in the execution queue) a new indexing operation for each document. At this moment, only basic information is fetched from the document. The document content is only retrieved during the indexing operation.

Indexing Operation

When an indexing operation is executed, the following actions are processed for each item to index:
Charset detection (and language detection, if necessary)
Charset conversion (if necessary)
Extraction, tokenization and indexation of each field (most of the fields use the default tokenizer but some fields, such as email, use different tokenizers).
   Index Queries

The query engine can be adapted to supports a limited or unlimited set of grammatical terms. In one embodiment, the system does not support exact phrase, due to some index size optimization and application size optimization. However, it the query engine can supports custom fields (@fieldname=value), Boolean operators, date queries, and several comparison operators (<=, >=, =, <, >) for certain fields.

Performing a Query

For each query, the Indexer executes the following actions:
The query is parsed
The query evaluator evaluates the query and fetches the matching DocID list.
The deleted documents are then removed from the matching DocID list.

From the matching DocID list, the application can add the items to its views; fetch additional document information, etc.

CPU Usage Monitoring

With reference to the CPU usage monitoring discussed above, one of ordinary skill in the art will appreciate that the algorithms used to detected the threshold CPU usage can vary.

On Windows NT-based operating systems, an alternative algorithm can be used. In one embodiment, the algorithm can be adjusted to allow more control on the threshold where indexing must be paused. The algorithm is:

Every Second:
Check Performance Counters
If (Total CPU Usage) − ( Indexing CPU Usage) > 40% Then
Pause Indexing

On Windows 9x, the check for kernel usage can be made more often and the pause before checking for kernel usage can be shortened. This makes indexing faster and allows the indexer to react more quickly to an increased CPU usage. One such algorithm is:

```
Every Second:
    Pause Indexing for 150 Milliseconds
    Check Kernel Usage
    If (Kernel Usage) = 100% Then
        Pause Indexing
```

For the monitoring of mouse and keyboard usage, the pause of the indexing process can vary. In one embodiment, the pause can last 2 minutes, which allows the indexer to be even more transparent to the user.

Described above are methods and apparatus meeting the desired objects, among others. Those skilled in the art will appreciate that the embodiments described herein and illustrated in the drawings are merely examples of the invention and that other embodiments, incorporating changes therein fall within the scope of the invention. Thus, by way of non-limiting example, it will be appreciated that embodiments of the invention may use indexing structures other than those described with respect to the illustrated embodiment. In that light, what is claimed is:

1. A method of updating a database, comprising:
indexing electronic mail documents and storing document information in a database;
registering with the extended MAPI layer of an email program for notification of changes to the documents; and
responding to received notification of changes by updating the database to reflect the addition, modification, and/or deletion of documents.

2. The method of claim 1, wherein the step of indexing includes assigning each document a unique document identifier.

3. The method of claim 2, wherein the step of indexing includes storing the unique document identifiers and associated document URIs in a file.

4. The method of claim 1, wherein the step of indexing includes storing a unique document identifier and one or more keywords for each indexed document in a file.

5. The method of claim 1, wherein the step responding includes storing information about the deleted status of documents in a file.

6. The method of claim 1, wherein the step of indexing further includes the steps of
a.) reserving a new unique document identifier for a new document,
b.) adding a document to a document database by writing a new entry for the new document, and
c.) associating the new document with a keyword.

7. The method of claim 6, wherein the step of adding a document includes a pre-commit stage, in which the database can be rolled back to its pre-document-addition state if the system unexpectedly shuts down.

8. The method of claim 7, wherein the pre-commit or commit status of documents are stored in a file.

9. The method of claim 1, further comprising searching indexed documents for documents matching a keyword.

10. The method of claim 1, wherein the indexing is paused when CPU usage rises above a threshold value.

11. The method of claim 1, further comprising monitoring at least one of a mouse and a keyboard and pausing the indexing when at least one of the mouse and keyboard is used.

12. An indexing system, comprising:
an indexer for indexing electronic mail documents;
a document database in communication with the indexer and adapted to store unique identifiers for each indexed document; and
an electronic mail monitor in communication with the indexer and adapted to detect the occurrence of newly received and newly created electronic mail documents, wherein the monitor can signal to the indexer when new electronic mail documents are received or created.

13. The system of claim 12, further comprising a keyword database in communication with the indexer and adapted to store unique identifiers for each indexed document and associated keywords.

14. The system of claim 12, wherein the document data base is in communication with a document ID index file that stores a list of unique identifiers for each indexed file and information about the indexed file.

15. A method of updating a database, comprising:
indexing electronic mail documents and storing document information in a database;
registering with the extended MAPI layer of an email program for notification of changes to the documents; and
responding to received notification of the addition of a document by updating the database to reflect the addition of the document.
